(19) United States
(12) Patent Application Publication
(10) Pub. No.: US 2025/0181283 A1
(43) Pub. Date: Jun. 5, 2025

(54) PRINTING APPARATUS, PRINT CONTROL METHOD, AND STORAGE MEDIUM

(71) Applicant: CANON KABUSHIKI KAISHA, Tokyo (JP)

(72) Inventor: Kenji Baba, Tokyo (JP)

(21) Appl. No.: 18/966,267

(22) Filed: Dec. 3, 2024

(30) Foreign Application Priority Data
Dec. 5, 2023 (JP) 2023-205282

(51) Int. Cl. G06F 3/12

(52) U.S. Cl. CPC G06F 3/1219; G06F 3/1251; G06F 3/1256

(57) ABSTRACT

A printing apparatus according to the present disclosure includes: a printing unit configured to execute printing on a continuous sheet; and a control unit configured to control the printing unit based on a print job including a first job for test printing and a second job for final printing. In a case where a plurality of the print jobs are input, the control unit controls the printing unit so as to collectively print the plurality of first jobs in the input plurality of print jobs on a first region on the continuous sheet, and collectively print the plurality of second jobs in the input plurality of print jobs on a second region present on a rear side in a conveyance direction of the continuous sheet relative to the first region on the continuous sheet on which the first jobs have been printed.

### BACKGROUND OF THE INVENTION

### Field of the Invention

The present disclosure relates to test printing for printing using a continuous sheet.

### Description of the Related Art

Conventionally, before printing a print job, test printing for checking the final appearance (hereinafter referred to as “proof printing”) is performed. In particular, for a print job with many pages, performing proof printing before final printing reduces the number of failed prints and can be expected to reduce waste in terms of both cost and work.

However, in a case of performing printing using a continuous sheet consistently from sheet feed through sheet discharge, a large blank portion appears between the region where proof printing is performed and the region where final printing is performed and will be wasted. This is because in the conventional operation follows a procedure in which, for each job, an operator visually checks the result of its proof printing and supplies a job for final printing in a case where the proof printing has no problem. Hence, every time proof printing is performed, the continuous sheet needs to be conveyed to a visual check position, thereby forming a blank portion over the distance which the continuous sheet is conveyed.

As a technology for performing proof printing using a continuous sheet, Japanese Patent Laid-Open No. 2017-052096 (Patent Document 1) discloses a method in which proof printing of a job following a preceding job is continuously executed after the completion of the preceding job. Using the technology of Patent Document 1 will reduce the blank portion that appears between the final printing of the preceding job and the proof printing and the proof printing of the following job.

Nonetheless, a blank portion appears between the proof printing of the following job and the final printing of the following job as in the conventional case even in the case where the technology of Patent Document 1 is used. In recent years in particular, there has been a trend towards an increase in small-lot orders for printing relatively small numbers of copies (pages) also in printing using continuous sheets. Accordingly, with the conventional method, the proportion of the blank portion to the printed portion is large as compared to that in large-lot orders, and therefore the impact of the blank portion poses a larger issue. An object of the present disclosure is to prevent a blank portion from appearing between test printing and final printing for printing on a continuous sheet.

### SUMMARY OF THE INVENTION

A printing apparatus according to the present disclosure includes: a printing unit configured to execute printing on a continuous sheet; and a control unit configured to control the printing unit based on a print job including a first job for test printing and a second job for final printing. In a case where a plurality of the print jobs are input, the control unit controls the printing unit so as to collectively print the plurality of first jobs in the input plurality of print jobs on a first region on the continuous sheet, and collectively print the plurality of second jobs in the input plurality of print jobs on a second region present on a rear side in a conveyance direction of the continuous sheet relative to the first region on the continuous sheet on which the first jobs have been printed.

Further features of the present invention will become apparent from the following description of exemplary embodiments with reference to the attached drawings.

### BRIEF DESCRIPTION OF THE DRAWINGS

FIG. 1 is a diagram illustrating a configuration of an entire printing system;

FIG. 2 is a block diagram illustrating a control configuration of the printing system;

FIG. 3 is a diagram illustrating an example of the result of conventional printing using a continuous sheet;

FIG. 4 is a diagram illustrating an example of the result of printing by a printing apparatus in a first embodiment;

FIG. 5 is a block diagram illustrating a functional configuration of the printing apparatus;

FIG. 6 is a diagram illustrating an example of a job list;

FIG. 7 is a flowchart illustrating a flow of a job acceptance and proof job generation process;

FIGS. 8A and 8B represent an example of user interfaces (UIs) for configuring proof settings;

FIG. 9 is an example of a UI for configuring the print settings;

FIG. 10 is a flowchart illustrating a flow of a print control process in the first embodiment;

FIG. 11 is a flowchart illustrating a process of determining proof jobs continuously printed;

FIG. 12 is a diagram illustrating an example of a UI for inputting a proof evaluation result;

FIG. 13 is a diagram illustrating a job list containing a re-generated proof job J0013;

FIG. 14 is a diagram illustrating an example of the result of printing by a printing apparatus in a second embodiment;

FIG. 15 is a block diagram illustrating a functional configuration of the printing apparatus in the second embodiment;

FIG. 16 is a diagram illustrating an example of a job list;

FIG. 17 is a flowchart illustrating a process of determining jobs to be printed in the second embodiment;

FIG. 18 is a block diagram illustrating a functional configuration of a printing apparatus in a third embodiment; and

FIG. 19 is a flowchart illustrating a process of determining jobs to be printed in the third embodiment.

### DESCRIPTION OF THE EMBODIMENTS

### First Embodiment

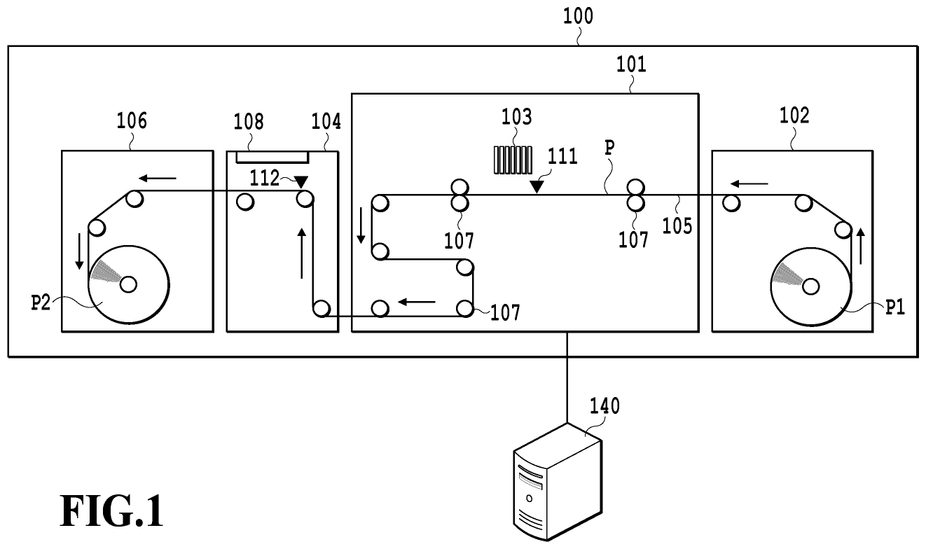

FIG. 1 is a diagram schematically illustrating a configuration of an entire printing system 100 including a printing apparatus 101 according to an embodiment of the present disclosure. As illustrated in FIG. 1, the printing system 100 includes the printing apparatus 101, a sheet feed unit 102, an inspection apparatus 104, and a sheet discharge unit 106. The printing system 100 incorporates a conveyance path 105 extending from the sheet feed unit 102 to the sheet discharge unit 106 by ways of the printing apparatus 101 and the inspection apparatus 104. A continuous sheet P drawn from a roll P1 set in the sheet feed unit 102 is conveyed along the conveyance path 105. Hereinafter, the continuous sheet will be referred to as “roll sheet.” The roll sheet will be described later.

Roller pairs each including a conveyance roller and an auxiliary roller are provided at multiple positions along the conveyance path 105 as conveyance mechanisms 107. The conveyance rollers are rotationally driven by a conveyance motor. The roll sheet P supplied from the sheet feed unit 102 by the conveyance mechanisms is guided into the printing apparatus 101, subjected to image forming by a printing unit 103, and discharged to the sheet discharge unit 106 through the inspection apparatus 104.

The printing unit 103 of the printing apparatus 101 includes a head that ejects inks and tanks that supply the inks to the head. The printing unit 103 ejects an ink or inks onto the roll sheet P conveyed to a print position 111 opposed to the head in accordance with print data supplied from a control unit to thereby form an image. The roll sheet P after the image forming by the printing apparatus 101 is conveyed along the conveyance path 105 to be subjected to steps such as drying, curing, and cooling and sent to the inspection apparatus 104.

The inspection apparatus 104 is provided with a visual check window 108 for the operator to check the image printed on the roll sheet P. The operator can visually check the actual print product through the visual check window 108. Incidentally, in a case where it is physically difficult to dispose the visual check window 108 on the printing system, the inspection apparatus 104 may be configured of a camera that captures an image of a print product and a monitor that displays the captured image.

After passing the inspection apparatus 104, the roll sheet P is sent to the sheet discharge unit 106 to be wound up into a roll and collected as a print product P2.

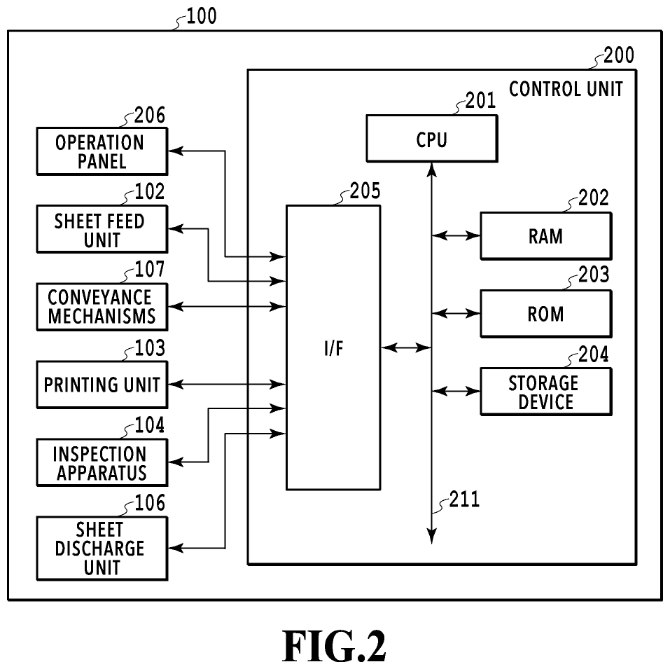

Note that the printing apparatus 101 is provided with a control unit 200 and operation panel 206 (FIG. 2) to be described later. Also, the printing apparatus 101 is communicatively connected to a host apparatus 140 through a network, such as a local area network (LAN).

The host apparatus 140 is a computer, such as a personal computer (PC). The host apparatus 140 executes an imposition process in accordance with the operator's operation, for example, to generate a print job and transmits it to the printing apparatus 101. The host apparatus 140 also receives information indicating a status of the printing system 100 and the like that are transmitted from the control unit of the printing apparatus 101 and displays them on a display unit (not illustrated) of the host apparatus 140. While FIG. 1 illustrates an example in which a single host apparatus 140 is connected to the printing apparatus 101, the configuration is not limited to this example, multiple the host apparatuses 140 may be connected to the printing apparatus 101.

Note that the term “printing” herein not only includes formation of meaningful information such as characters or a figure but broadly encompasses formation of an image, a design, and a pattern on a continuous sheet, regardless of whether it is meaningful or not. The term also includes processing of the medium, and is not limited by whether the result is visually perceptible to humans.

Also, the print medium used in the present embodiment is a continuous sheet that is continuous in the longitudinal direction, and is a roll sheet, for example. The roll sheet is not limited to paper, and may be a non-paper material such as fabric or a plastic film. Also, the continuous sheet used in the present embodiment may be a label roll sheet being release paper to which multiple labels are detachably attached with an adhesive or the like. While the components of the inks are not particularly limited, the present embodiment assumes a case of using aqueous pigment-based inks each containing a pigment, which is a color material, water, and a resin.

Also, the present embodiment will be described by taking an inkjet printer that uses inks as printing materials as an example, but is not limited to this method. The present disclosure encompasses thermal printers (sublimation type, heat transfer type, etc.), dot impact printers, LED printers, laser printer, and electrophotographic printing machines using toners, and is applicable to printing apparatuses of various printing methods.

FIG. 2 is a block diagram illustrating a control configuration of the printing system 100. The control unit 200 of the printing apparatus 101 has a central processing unit (CPU) 201, a random-access memory (RAM) 202, a read-only member (ROM) 203, a storage device 204, a general-purpose interface (I/F) 205, and so on. The elements in the control unit 200 are connected to one another by a main bus 211.

The CPU 201 is a processor that comprehensively controls elements of the printing system 100. The CPU 201 calls programs stored in the ROM 203, the storage device 204, or the like into a work area in the RAM and execute them. The RAM 202 functions as a main memory, a work area, and the like for the CPU 201. The ROM 203 stores a set of programs to be executed by the CPU 201. A hard drive disk (HDD), a solid-state drive (SSD), a flash memory, or the like is used as the storage device 204, and stores programs to be executed by the CPU 201, job data to be used in printing, image data, and so on.

The programs include a program related to a print control method according to the present disclosure. The CPU 201 functions to implement the present disclosure's units by executing the processes to be described later in accordance with the program. The function will be described later. The general-purpose I/F 205 includes universal serial bus (USB) and LAN interfaces and the like and accepts job data transmitted from the host apparatus 140.

Also, the operation panel 206, the sheet feed unit 102, the conveyance mechanisms 107, the printing unit 103, the inspection apparatus 104, the sheet discharge unit 106, and so on are connected to the control unit 200 through the general-purpose I/F 205. The control unit 200 controls the operations of the operation panel 206, the sheet feed unit 102, the conveyance mechanisms 107, the printing unit 103, the inspection apparatus 104, and the sheet discharge unit 106.

The operation panel 206 includes a display unit including a liquid crystal display or the like and an input unit including a touch panel, various keys, or the like. The display unit displays information on a current status and settings of the printing system 100 and the like input from the CPU 201. The input unit inputs information input by the operator's operation into the CPU 201. For example, the input unit inputs printing resumption instructions, proof settings, and so on.

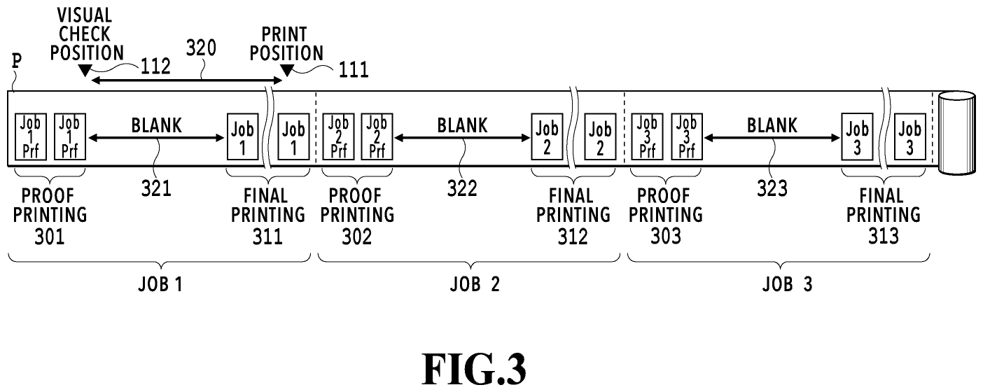

Now, a conventional problem with proof printing using a continuous sheet will be described with reference to FIG. 3. FIG. 3 illustrates the result of conventional printing using a continuous sheet consistently from sheet feed through sheet discharge. In conventional proof printing, proof printing 301 for “JOB 1” is performed for one to several pages at the print position 111 in the printing apparatus 101, and then the roll sheet P is conveyed to a visual check position 112 in the inspection apparatus 104. Then, in a case where the operator determines “ACCEPTABLE” in a visual check, the print data for “JOB 1” is supplied from the control unit, and final printing 311 is executed for all pages at the print position 111.

In such a printing procedure, a large blank portion 321 without printing appears between the proof printing 301 and the final printing 311. The length of the blank portion 321 corresponds to a distance 320 from the print position 111 to the visual check position 112 on the conveyance path. In a case of accepting multiple print jobs (jobs 1, 2, and 3) in a row, a similar process will be performed for each of the jobs 1, 2, and 3.

This results in the blank portion 321 appearing between the proof printing 301 and the final printing 311 for the job 1, a blank portion 322 appearing between proof printing 302 and final printing 312 for the job 2, and a blank portion 323 appearing between proof printing 303 and final printing 313 for the job 3. In the present embodiment, these blank portions are prevented from appearing.

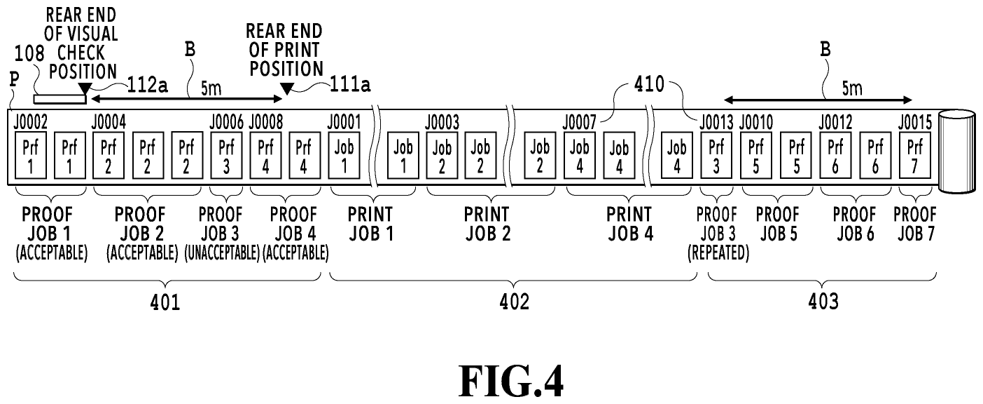

FIG. 4 is a diagram illustrating the result of printing by the printing apparatus 101 in the present embodiment. The direction from the right to the left in FIG. 4 is the conveyance direction of the roll sheet P in the printing apparatus 101. That is, the left side in the diagram is the front side in the conveyance direction, and the right side in the diagram is the rear side in the conveyance direction.

In the present disclosure, in a case of accepting multiple print jobs in which the printing apparatus 101 will use the same type of sheet, proof printing operations for those print jobs (proof jobs 1, 2, 3, and 4) will be executed collectively and continuously. Then, the operator visually checks each of those multiple proof printing operations. For the proof printing operations with proofs determined as acceptable (ready for final printing), the print jobs associated as the source jobs (print jobs 1, 2, and 4) are subjected to final printing.

Thereafter, a re-proof printing operation for the job with a proof determined as unacceptable (proof job 3) and proof printing operations for other jobs accepted subsequently (proof jobs 5, 6, and 7) are executed collectively and continuously. Then, the operator visually checks each of those multiple proof printing operations, and the source print jobs for the proof printing operations with proofs determined as acceptable (ready for final printing) are continuously subjected to final printing.

As a result, multiple proof jobs are collectively printed on a first region 401. Moreover, the print jobs determined to be ready for final printing in their proof evaluations are subjected to final printing on a second region 402 present behind the first region 401. In the following description, the first region on the roll sheet P on which to perform proof printing will be referred to also as “proof region.” Also, the second region on which to perform final printing will be referred to also as “final printing region.”

In the first embodiment, as illustrated in FIG. 4, proof jobs to be continuously printed are determined such that the length of the proof regions 401 and 403 exceeds the length of the conveyance path 105 from a rear end 111a of the print position 111 on the conveyance path to a rear end 112a of the visual check position 112 on the conveyance path (hereinafter referred to as “conveyance path length B”). That is, multiple proof jobs are set to be continuously printed such that the total of print lengths being the lengths of the proof jobs printed on the roll sheet P will exceed the conveyance path length B. A print length is determined for each job and is stored in a job list in association with the job. The job list will be described later.

In the example of FIG. 4, the proof job 1 (Prf1) for the print job 1 (Job1), the proof job 2 (Prf2) for the print job 2 (Job2), the proof job 3 (Prf3) for the print job 3 (Job3), and the proof job 4 (Prf4) for the print job 4 (Job4) are continuously printed to form a series of proof regions 401.

Suppose that, of the four proof jobs, the proof jobs 1, 2, and 4 (Prf1, Prf2, and Prf4) are determined as acceptable and the proof job 3 (Prf3) is determined as unacceptable in the visual checks by the operator. In that case, the print jobs 1, 2, and 4 (Job1, Job2, and Job4) associated with the proof jobs 1, 2, and 4 (Prf1, Prf2, and Prf4) as their respective source jobs are continuously subjected to final printing on the final printing region 402 following the proof region 401.

The proof job 3 (Prf3) determined as unacceptable is re-printed on the next first region 403 following the final printing region 402. Here, the proof jobs to be continuously printed are determined such that the total of the print lengths of the proof jobs yet to be printed and re-printed will exceed the conveyance path length B. In the example of FIG. 4, the proof job 3 (Prf3) to be re-printed and the proof jobs 5, 6, and 7 (Prf5, Prf6, and Prf7) for print jobs 5, 6, and 7 (Job5, Job6, and Job7) are continuously printed on the first region 403 present behind the final printing region 402. As a result, a series of proof regions 403 are formed.

A functional configuration of the printing apparatus 101, which executes printing as illustrated in FIG. 4, will now be described below.

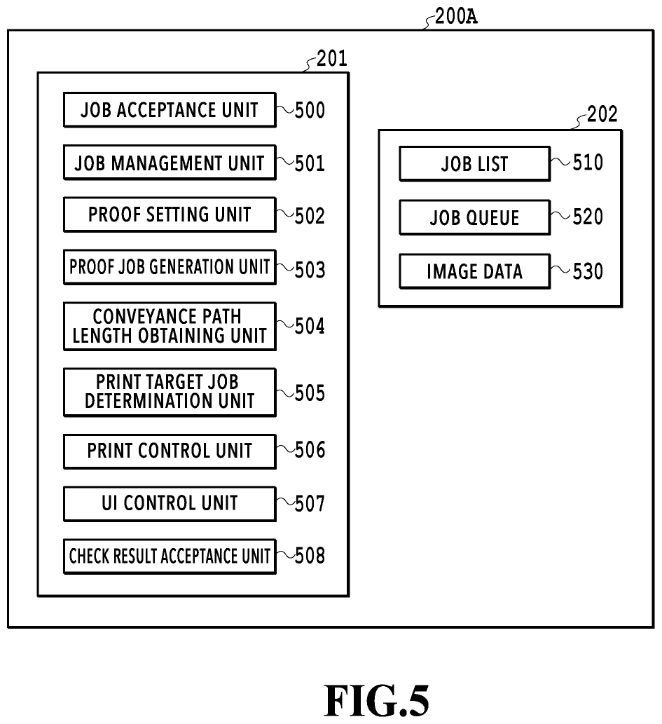

FIG. 5 is a block diagram illustrating the functional configuration of the printing apparatus 101 in the first embodiment. The printing apparatus 101 has a job acceptance unit 500, a job management unit 501, a proof setting unit 502, a proof job generation unit 503, a conveyance path length obtaining unit 504, a print target job determination unit 505, a print control unit 506, a UI control unit 507, a check result acceptance unit 508, and so on.

Also, the RAM 202 stores a job list 510, a job queue 520, and image data 530 to be described later, and so on. The CPU 201 implement the functions of the above units 500 to 508 by calling programs stored in the ROM 203 or the storage device 204 and executing processes in accordance with the programs.

The job acceptance unit 500 accepts print jobs transmitted from the host apparatus 140 and registers the received print jobs' data (hereinafter referred to as “print jobs”) into the job list 510. Each print job contains image data to be printed, information on mechanical control of the printing apparatus 101, a print setting indicating the printing method, information on the sheet to be used, and so on. The order of registration of the jobs into the job list 510 is the order of acceptance of the jobs.

The job management unit 501 manages the print jobs and proof jobs registered in the job list 510. Specifically, the job management unit 501 generates instances from job information including information for controlling the jobs, information on the associations between the print jobs (second jobs for final printing) and their proof jobs (first jobs for test printing), print attributes (including print settings such as the print layout), and so on. With the each print job or proof job's instance, the job management unit 501 determines the print length of the job, or the length on the roll sheet over which to print the job. The job management unit 501 also manages the statuses of the print jobs and the order of printing thereof.

The job queue 520 provides a scheme for scheduling printing, such as determining the order of printing. The job management unit 501 sequentially processes the print jobs in the order stored in the job queue 520. The job list 510 will be described later.

The proof setting unit 502 accepts configuration of proof printing by the operator. Specifically, the proof setting unit 502 lets the operator select pages to be subjected to proof printing from among all pages in print jobs, and accepts the print settings for the proof printing. At this time, the proof setting unit 502 preferably displays a display screen (UI) for accepting the operator's operations on the operation panel 206. The UI will be described later.

The proof job generation unit 503 generates jobs dedicated for proof printing (hereinafter referred to as “proof jobs”) based on proof setting values set by the proof setting unit 502 and registers them into the job list 510. The order of registration into the job list 510 is the order of generation of the proof jobs.

Specifically, the proof job generation unit 503 duplicates proof jobs from instances of print jobs that serve as sources for the duplication (hereinafter referred to as “source jobs”) among the print jobs managed in the job list 510. The proof jobs generated by the proof job generation unit 503 and the instances of the respective source jobs are associated with each other. It is possible to identify a source job from a proof job and conversely identify a proof job from a source job.

The conveyance path length obtaining unit 504 obtains information on the length of the conveyance path 105 between the print position 111 and the visual check position 112 on the conveyance path. More specifically, the conveyance path length obtaining unit 504 obtains information on the length of the conveyance path 105 between the rear end 111a of the print position 111 and the rear end 112a of the visual check position 112 (hereinafter referred to as “conveyance path length B”). In the present embodiment, the conveyance path length B is stored in the ROM 203 or the like in advance as apparatus information.

The print target job determination unit (hereinafter referred to as “determination unit”) 505 determines multiple proof jobs to be printed on the first region 401 based on the length over which to the print jobs and the proof jobs on the roll sheet. In the first embodiment, the determination unit 505 determines multiple proof jobs to be continuously printed on the first region based on the conveyance path length B obtained by the conveyance path length obtaining unit 504.

The determination unit 505 determines the multiple proof jobs to be printed on the first region such that the total of the lengths over which to print the proof jobs excluding the proof job to be printed first among the multiple proof jobs to be printed on the first region will exceed the conveyance path length B.

The reason to calculate the total excluding the print length of the proof job to be printed first is to prevent a blank portion from appearing between the proof region and the final printing region even in a case where the operator determines that the proof of the leading proof job is unacceptable. As a result of performing printing such that no blank portion will appear between the proof region and the final printing region as described above, the proof region 401 and the following final printing region 402 will be adjacent to each other.

Also, it is preferable that, even in a case where the total is the conveyance path length B or less, the printing can be started if the operator inputs a print instruction. This is because there are cases where delivering a print product before the deadline without waiting for reception of the next print job is prioritized in actual operations. Note that, even in the case where the total does not exceed the conveyance path length B as above, the blank portion that will appear on the roll sheet P will be reduced as compared to the conventional method (FIG. 3) as long as multiple proof jobs are continuously printed.

The determination unit 505 stores the multiple proof jobs determined as continuous printing targets in the job queue 520.

The determination unit 505 also determines print jobs to be subjected to final printing. Specifically, in a case where the operator visually checks the result of proof printing and inputs information indicating permission to perform final printing, the determination unit 505 determines that the print job associated with that proof job as its source job is to be subjected to final printing. Such a print job is stored after the multiple proof jobs already stored in the job queue 520.

The print control unit 506 controls print processing of the jobs to be printed determined by the determination unit 505. In the print processing, the print control unit 506 identifies the jobs to be printed from the job list 510, and performs their print processing. In the print processing, the print control unit 506 refers to the instances of the print jobs and the generated proof jobs, performs a raster image processor (RIP) process to generate raster images (image data 530), and store them in the RAM 202. The print control unit 506 also transmits a print instruction, print data, and the like to the printing unit 103 in response to an instruction from the control unit 200.

The printing unit 103 ejects an ink or inks in accordance the print data transmitted from the print control unit 506 to perform printing on the roll sheet P.

The print control unit 506 prints the proof jobs among the multiple jobs managed by the job management unit 501 collectively on the first region 401 on the roll sheet as described above. The print control unit 506 also executes final printing of the print jobs associated with the proof jobs printed on the first region 401, on the second region 402 present behind the first region 401.

The UI control unit 507 displays UIs on the operation panel 206 and accepts the operator's (user's) operations thereon. The operator can operate the UIs to input operations (such as initiation, suspension, and cancellation) for jobs registered in the job list, proof settings, various parameters, the results of visual checks on proof printing operations, and so on. A specific example of the UIs will be described later.

The check result acceptance unit 508 accepts, for each printed proof job, input of information indicating whether the results of the visual check by the operator indicates that the print job is ready for final printing or not. The check result acceptance unit 508 preferably displays a screen (UI) for inputting the results of the visual checks by the operator on the operation panel 206.

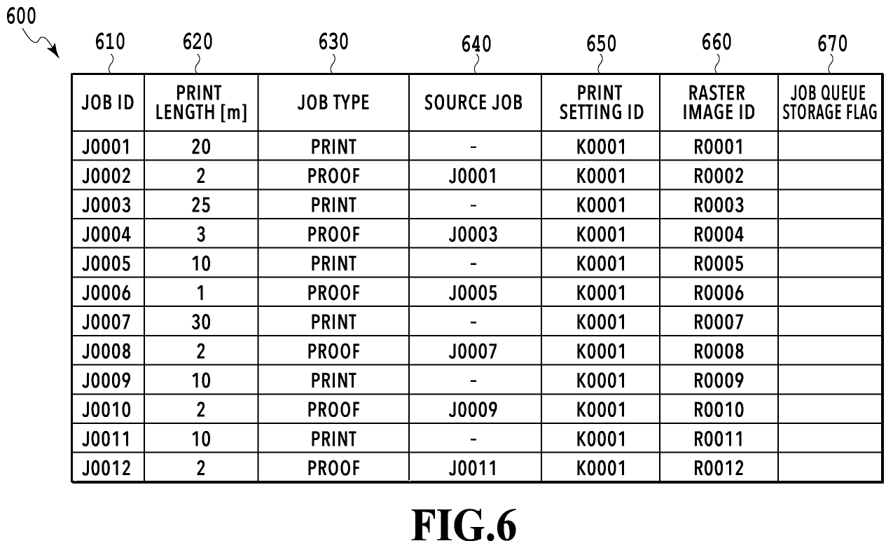

Next, a job list will be described with reference to FIG. 6. A job list 600 in FIG. 6 represents an example in which information on print jobs to be printed on the same type of sheet among print jobs accepted by the job acceptance unit 500 is registered. Also, information on proof jobs generated by the proof job generation unit 503 is registered in the job list 600 as well. For each job, pieces of information such as a job identifier (ID) 610, a print length 620, a job type 630, a source job 640, a print setting ID 650, a raster image ID 660, and a job queue storage flag 670 are stored in association with one another.

The job ID 610 is information for identifying a job, and is generated by the job management unit 501 in a case of registering the job into the job list 600. In this example, the job IDs 610 are numbers assigned in ascending order as J0001, J0002, J0003, J0004, . . . based on the order of registration into the job list.

The print length 620 is information indicating the length over which to print the job on the roll sheet P. The print length is determined by the job management unit 501 based on the instance of a print job or a proof job.

The job type 630 is information indicating whether the job is a print job or a proof job.

The source job 640 is information registered in a case where the job type is a proof job. The job ID of the print job from which the proof job has been duplicated is stored.

The print setting ID 650 is identification information of print setting information set for the print job of the proof job. The print setting information associated with the print setting ID 650 is stored in the RAM 202.

The raster image ID 660 is identification information of a raster image or raster images generated from the print job or the proof job. The raster image data associated with the raster image ID 660 is stored in the RAM 202 or the like.

The job queue storage flag 670 is set to “ON” in a case where the job is stored in the job queue 520. In a case where a proof job is determined to be printed on a proof region by the determination unit 505, the proof job is stored in the job queue 520. In a case where a print job is determined as acceptable in its proof evaluation or no proof is determined to be necessary (proof printing is not to be performed), the print job is stored in the job queue 520.

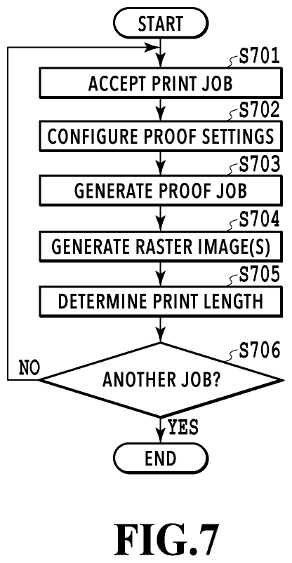

Next, a flow of a job acceptance and proof job generation process executed by the printing apparatus 101 will be described with reference to FIG. 7. The processes illustrated in the flowcharts to be described below are each executed by the control unit 200 calling a program stored in the ROM 203 or the storage device 204 and loading the program to the RAM 202 and the CPU 201 executing the program. The printing apparatus 101 starts the process of the flowchart in FIG. 7 in a case where a print job is transmitted from the host apparatus 140. Each symbol “S” in the following description represents a step.

In S701, the CPU 201 (job acceptance unit 500) accepts a print job transmitted from the host apparatus 140. The CPU 201 (job management unit 501) generates an instance from job information including information for controlling the print job, information on the association with other print data, print attributes (including print settings such as the print layout), and so on, and registers the instance into the job list 600.

For example, in response to receiving a first print job, the CPU 201 (job acceptance unit 500) registers newly registers it into the job list 600. The CPU 201 (job management unit 501) assigns a job ID 610 to newly registered job. For example, “J0001” is assigned. Also, the CPU 201 (job management unit 501) stores “PRINT” as the job type 630 of the print job “J0001.” Further, the CPU 201 (job management unit 501) obtains the print settings from the received print job and registers them as “K0001,” which is a print setting ID 650.

In S702, the CPU 201 (proof setting unit 502 and UI control unit 507) displays an UI or UIs for configuring the proof settings on the operation panel 206 and accepts the operator's operation thereon.

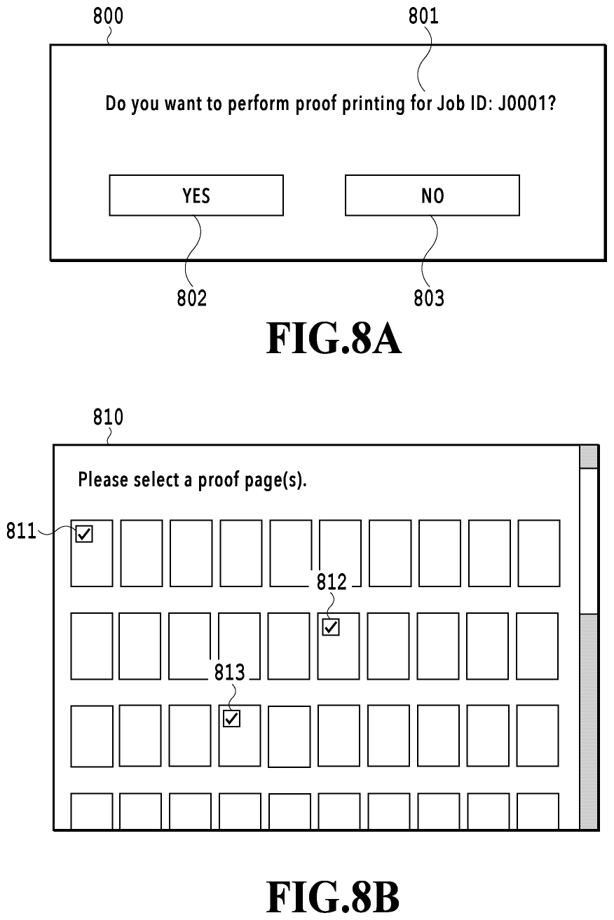

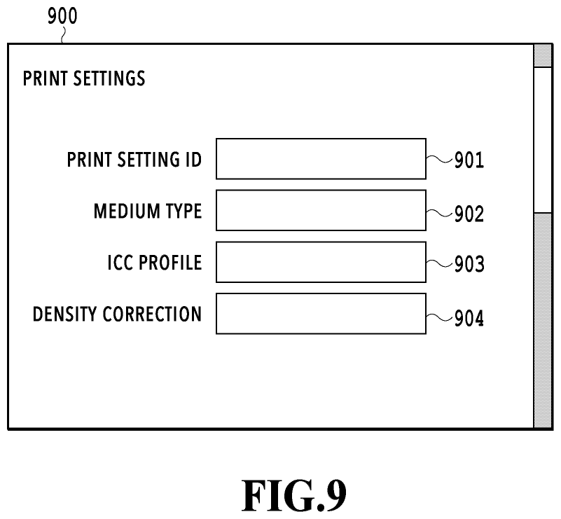

A UI 800 illustrated in FIG. 8A is a screen for having the operator select whether to execute proof printing. A UI 810 illustrated in FIG. 8B is a screen for having the operator select a page or pages to be subjected to proof printing from among all pages in a print job. A UI 900 illustrated in FIG. 9 is a screen for accepting the print settings of proof printing.

As illustrated in FIG. 8A, in the UI 800, a message 801 “Do you want to perform proof printing for Job ID: J0001?” is displayed, confirming whether to perform proof printing for an accepted print job. Also, a “YES” button 802 and a “NO” button 803 are provided in the UI 800. The “YES” button 802 is operated in a case where proof printing is needed. The “NO” button 803 is operated in a case where proof printing is not needed. In a case where the “YES” button 802 is operated, the screen transitions to the UI 810 illustrated in FIG. 8B.

As illustrated in FIG. 8B, in the UI 810, preview images or the page numbers of all pages in the print job are displayed. In the case of displaying the preview images, the CPU 201 refers to the print job and generates the preview images to display this UI 810. Each single rectangle in the diagram represents a page. In a case where the operator selects pages to be subjected to proof printing, check marks 811, 812, and 813 are displayed on the selected pages. This example indicates that three pages in the print job have been set as pages to be subjected to proof printing. After a page or pages to be subjected to proof printing are set, the screen transitions to the UI 900 illustrated in FIG. 9.

As illustrated in FIG. 9, the UI 900 for having the operator select the print settings of a proof job includes setting items such as a print setting ID, a medium type, an ICC profile, and density correction, and is provided with setting fields 901 to 904 for the respective setting items. The print setting ID is assigned by the CPU 201. The operator can set desired values to the medium type, the ICC profile, a density correction table, and the like. Here, the first proof printing tends to be performed with the same print settings as its source print job. Thus, the initial values may be the same print settings as those of the source print job. Incidentally, the operator can edit the print settings as well.

Note that it is possible to perform final printing without proof printing in a case where the option indicating that no proof is necessary (“NO” button 803) is selected in the UI 800 in FIG. 8A. In the case where no proof printing is necessary, the UIs 810 and 900 will not be displayed, and no proof job will be generated.

After S702 to configure the proof settings is S703, in which the CPU 201 (proof job generation unit 503) duplicates a proof job, which is a print job dedicated for proof printing, from the instance of the source job managed in the job list 600. After the proof job is generated, the job management unit 501 assigns a new job ID 610 and stores it in the job list 600, and also stores information indicating that the job is a proof job as the job type 630.

Further, the CPU 201 stores the print setting ID 650 set by the proof setting unit 502. The CPU 201 also stores the job ID 610 of the print job from which the proof job has been duplicated as the source job 640. In this way, the instances of the proof job and the print job as its source job are associated with each other. Hence, it is possible to identify the source job from the proof job and conversely identify the proof job from the source job, for example.

In S704, the CPU 201 generates a raster image or raster images by referring the instances of the print job and the proof job and performing a RIP process, and stores the raster image or raster images in the RAM 202.

In S705, the CPU 201 (job management unit 501) determines the length over which to print the print job on the roll sheet (print length) from the instance of the print job, and registers the length as the print length 620 in the job list 600. For example, the print length 620 of the print job “J0001” is 20 m. Also, in a case where a proof job has been generated, the CPU 201 (job management unit 501) determines the print length over which to print that proof job on the roll sheet, and registers it as the print length 620 in the job list 600. For example, the print length of the proof job “J0002” is 2 m. This print length is the print length of the three pages selected on the UI 810 (FIG. 8B).

In S706, the CPU 201 checks whether a next job has been received from the host apparatus 140. If a next job has been received (S706: YES), the CPU 201 returns to S701 and repeats the processes of S701 to S705 to add a job to the job list 600 as appropriate. If no next job has been received (S706: NO), the CPU 201 terminates the flowchart.

Suppose that the job list 600 illustrated in FIG. 6 is generated as a result of the process in FIG. 7. In the job list 600 illustrated in FIG. 6, six print jobs J0001, J0003, J0005, J0007, J0009, and J00011 are registered. Also, six proof jobs J0002, J0004, J0006, J0008, J0010, and J0012, whose source jobs are the above print jobs, are registered. The print lengths of the proof jobs J0002, J0004, J0006, J0008, J0010, and J0012 are 2 m, 3 m, 1 m, 2 m, 2 m, and 2 m, respectively. The print lengths of the print jobs J0001, J0003, J0005, J0007, J0009, and J00011 are 20 m, 25 m, 10 m, 30 m, 10 m, and 10 m, respectively.

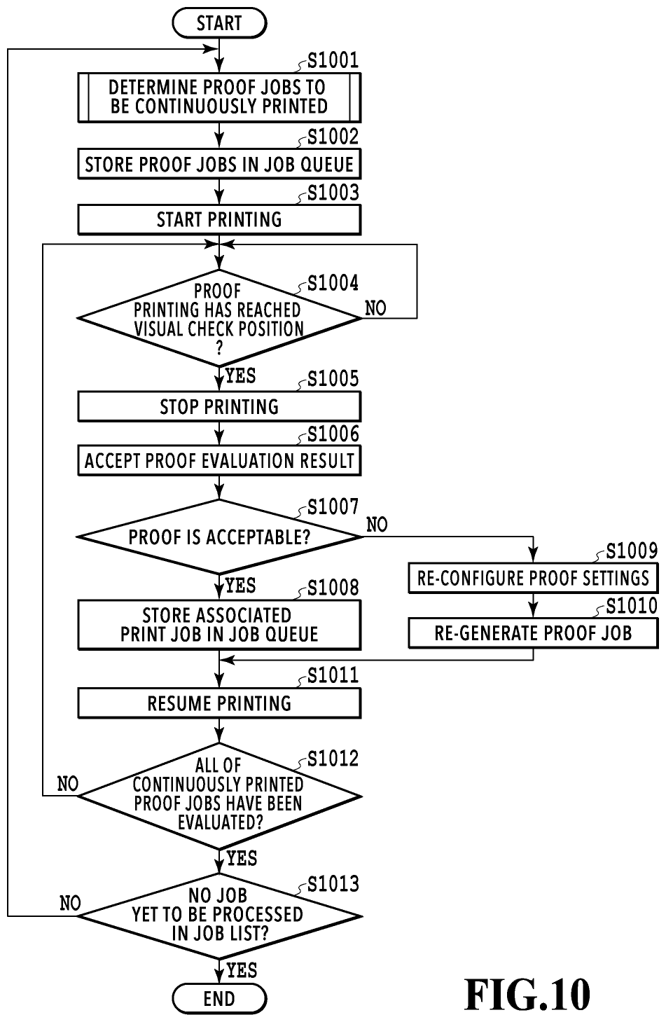

Next, a flow of a print control process executed by the printing apparatus 101 in the present embodiment will be described with reference to FIG. 10. The printing apparatus 101 starts the print control process in response to input of a print start instruction. Here, suppose that multiple print jobs and proof jobs have been registered in the job list 600 as illustrated in FIG. 6 at the point when the print control process in FIG. 10 is started. All of these jobs have been set in advance as jobs that use the roll sheet P of the same type.

In S1001, the CPU 201 (determination unit 505) determines proof jobs to be continuously printed. The CPU 201 determines the proof jobs to be continuously printed based on the information of the print lengths 620 in the job list 600 and the length of the conveyance path between the rear end 111a of the print position and the rear end 112a of the visual check position (conveyance path length B).

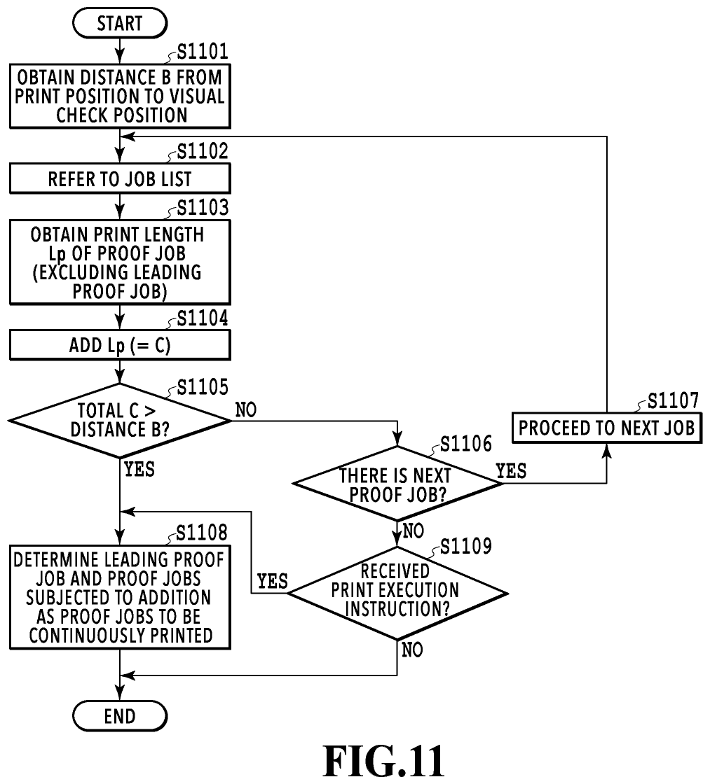

A procedure of the process of determining the proof jobs to be continuously printed will now be described with reference to FIG. 11. In a case of starting the process in FIG. 11, the CPU 201 initializes a variable C (=0) to be used in the following calculation.

In S1101, the CPU 201 (conveyance path length obtaining unit 504) obtains the distance from the print position to the visual check position (conveyance path length B). In this example, the conveyance path length B is 5 m.

In S1102, the CPU 201 (determination unit 505) sequentially refers to jobs in the job list 600 illustrated in FIG. 6 from the top job. In this step, the CPU 201 (determination unit 505) refers to the proof jobs among the registered jobs.

In S1103, the CPU 201 (determination unit 505) obtains a print length Lp of a proof job.

In S1104, the CPU 201 (determination unit 505) adds the obtained print length Lp of the proof job to the variable C. In doing so, the CPU 201 excludes the print length of the top proof job “J0002” in the job list 600 and adds the print length of the next proof job “J0004” or of a subsequent proof job. This is done because the trailing end of the last page in the proof job to be printed first needs to pass the rear end 112a of the visual check position in order for the operator to visually check the proof and determine whether it is acceptable or unacceptable.

In S1105, the CPU 201 (determination unit 505) determines whether the total C in S1104 exceeds the conveyance path length B. The CPU 201 (determination unit 505) proceeds to S1108 if the total C exceeds the conveyance path length B, and proceeds to S1106 if the total C is less than or equal to the conveyance path length B.

In S1106, the CPU 201 (determination unit 505) determines whether there is a next proof job in the job list 600. The CPU 201 (determination unit 505) proceeds to S1107 if there is a next proof job. The CPU 201 (determination unit 505) proceeds to S1109 if there is not a next proof job.

In S1107, the CPU 201 (determination unit 505) proceeds to the next proof job in the job list 600 and returns to S1102. The processes of S1102 to S1107 are repeated to add the print lengths Lp of the multiple proof jobs to the value C in the order of registration in the job list 600. The CPU 201 repeats the addition until the total C exceeds the conveyance path length B (5 m).

If the total C exceeds the conveyance path length B (5 m) (S1105: YES), then in S1108, the CPU 201 (determination unit 505) determines the leading proof job “J0002” and the proof jobs subjected to the addition in S1104 as proof jobs to be continuously printed.

In the example using the job list 600 in FIG. 6,

$$C = 3 m ( J0004 ) + 1 m ( J0006 ) + 2 m ( J 0008 ) > 5 m .$$

Specifically, the CPU 201 determines the four proof jobs including the proof jobs J0004, J0006, and J0008 used in the addition to the value C and additionally the leading proof job J0002 as proof jobs to be continuously printed.

A process in a case where the total C has not exceeded the conveyance path length B and it is determined in S1106 that there is not a next proof job (S1109) will be described later. After determining the proof jobs to be continuously printed, the CPU 201 terminates the flowchart of FIG. 11 and proceeds to S1002 in FIG. 10.

In S1002, the CPU 201 sequentially stores the proof jobs to be continuously printed determined in S1001 in the job queue 520 from the leading proof job. In the example mentioned above, the proof jobs J0002, J0004, J0006, and J0008 are sequentially stored in the job queue 520. The CPU 201 also sets the job queue storage flags 670 for these proof jobs J0002, J0004, J0006, and J0008 in the job list 600 to “ON.”

In S1003, the CPU 201 (print control unit 506) refers to the job queue 520 and the job list 600 and sequentially issues print start instructions to the printing unit 103.

During the proof printing, the CPU 201 instructs the printing unit 103 to print the job ID 610 of the proof job near the proof image. Further, the CPU 201 may instruct the printing unit 103 to print the print setting ID 650. The CPU 201 (print control unit 506) generates print data in accordance with a print instruction and the print setting and supplies the print data to the printing unit 103. The printing unit 103 ejects an ink or inks from the head in accordance with the print data to sequentially print the multiple proof jobs J0002, J0004, J0006, and J0008 on the roll sheet P.

During the printing, the CPU 201 monitors the conveyance position at which each proof job is printed.

In S1004, the CPU 201 determines whether the trailing end of the last page in the proof printing has been conveyed to the rear end 112a of the visual check position. If the position of the trailing end of the last page in the proof printing reaches the rear end 112a of the visual check position (S1004: YES), the CPU 201 stops the printing in S1005. If the position of the trailing end of the last page in the proof job has not reached the visual check position (S1004: NO), the CPU 201 continues the printing and the monitoring of the conveyance position.

In S1006, while the printing is stopped, the CPU 201 accepts input of the result of a visual check on the proof printing by the operator. In the following description, the result of a visual check on proof printing by the operator will be referred to as “proof evaluation result”. The CPU 201 (UI control unit 507) displays a UI 1200 for inputting the job ID of the proof printing and whether its proof evaluation result is acceptable (ready for final printing) or unacceptable (not ready for final printing) on the operation panel 206, and accepts the operator's inputs thereon.

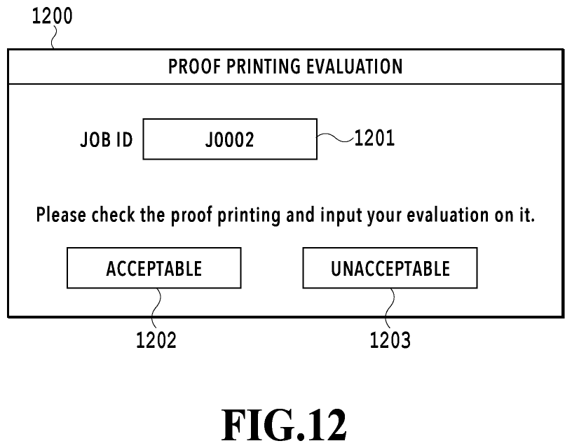

FIG. 12 is a diagram illustrating an example of the UI 1200 for inputting whether the proof evaluation result is acceptable or unacceptable. The operator refers to the job ID printed near the printed proof image and inputs it into a job ID field 1201 in the UI 1200. The operator also visually checks the result of the proof printing, and presses an “ACCEPTABLE” button 1202 in a case where the operator determines that final printing can be performed, and presses an “UNACCEPTABLE” button 1203 in a case where final printing cannot be performed.

In S1007, the CPU 201 switches the processing based on whether the proof evaluation result input into the UI 1200 was acceptable or not. The CPU 201 proceeds to S1008 if the “ACCEPTABLE” button 1202 was pressed, and proceeds to S1009 if the “UNACCEPTABLE” button 1203 was pressed.

If the proof evaluation result is acceptable, then in S1008, the CPU 201 refers to the job list 600 and stores the print job J0001, which is the source job for the job ID “J0002” input in the UI 1200, in the job queue 520.

As mentioned above, the proof jobs J0002, J0004, J0006, and J0008 to be continuously printed have already been stored in the job queue 520. The source job J0001 of the proof job J0002, whose proof evaluation result was input as “ACCEPTABLE” in S1006, is stored after the stored proof job J0008. Also, the CPU 201 sets the job queue storage flag 670 associated with the print job J0001 in the job list 600 to “ON.”

If the proof evaluation result is unacceptable, then in S1009, the CPU 201 (proof setting unit 502) accepts re-configuration of the proof printing for the print job J0001, which is the source job for the job ID “J0002” input into the UI 1200. Specifically, the CPU 201 displays the UIs 810 and 900 for configuring the print settings on the operation panel 206 and accepts the operator's inputs thereon. Viewing the result of the proof printing, the operator changes to the print settings to desired ones.

In S1010, the CPU 201 (proof job generation unit 503) re-generates a proof job and adds it to the job list 600. The content details are similar to S703. The re-generated proof job is associated with the source job as well. Note that a new job ID is assigned to the re-generated proof job, and written over the position of the job ID of the proof job that has been determined as unacceptable in the job list 600.

After completing the process of S1008 or S1010, the CPU 201 resumes the stopped printing in S1011.

In S1012, the CPU 201 determines whether the operator has performed proof evaluation on all of the continuously printed proof jobs.

If there is still a proof job or proof jobs yet to be subjected to proof evaluation (S1012: NO), the CPU 201 returns to S1004. In a case where the trailing end of the last page in the next proof job J0004 is moved to the visual check position 112, the CPU 201 stops the printing again, and the operator checks the result of the proof printing and inputs a proof evaluation result. If proof evaluation has been fined for all of the continuously printed proof jobs (S1012: YES), the CPU 201 proceeds to S1013.

As illustrated in FIG. 4, of the continuously printed proof jobs J0002, J0004, J0006, and J0008, the proofs of the proof jobs J0002, J0004, and J0008 are determined as acceptable. Moreover, the print jobs J0001, J0003, and J0007, which are the source jobs of those proof jobs, are printed on the region 402 following the proof region 401. The proof of the proof job J0006 has been determined as unacceptable, and the print job J0005, which is its source job, is therefore not printed on the region 402. Note that the order of printing of the print jobs J0001, J0003, and J0007 is the same as the order of printing of the associated proof jobs in the example of FIG. 4, but does not necessarily have to be the same order.

As for the proof job J0006, whose proof has been determined as unacceptable, the operator re-sets a proof job. The re-set proof job is assigned the newest job ID at that point, such as “J0013,” which is written over the position where the job ID of the proof job J0006 has been stored.

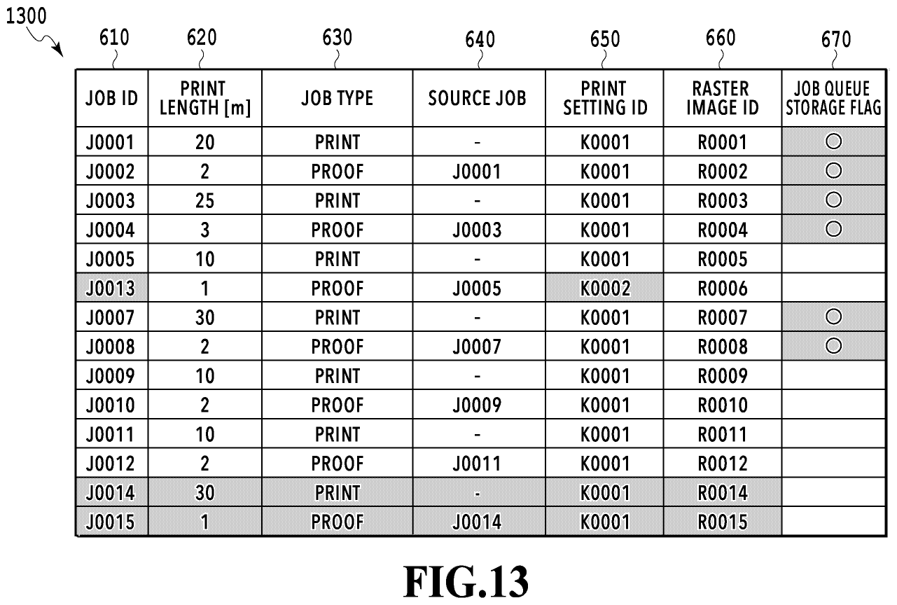

A job list 1300 illustrated in FIG. 13 illustrates the state of the job list at the point when it is determined that proof evaluation has been finished for all of the continuously printed proof jobs in S1012. Incidentally, in FIG. 13, the portions different from those of the job list 600 illustrated in FIG. 6 are depicted in gray.

In the job list 1300, the re-generated proof job J0013 is written over the position where the proof job J0006 determined as unacceptable has been stored. That is, the job ID which has been J0006 is now changed to J0013, and the print setting ID is changed to K0002. Also, the job queue storage flags 670 for the jobs J0001, J0002, J0003, J0004, J0007, and J0008 are set to “ON.” Further, a new print job J0014 and its proof job J0015 are added.

In S1013, the CPU 201 determines whether there is a job or jobs yet to be processed in the job list 1300. Specifically, the CPU 201 refers to the job queue storage flags 670 in the job list 1300 and, if there is a print job or print jobs whose job queue storage flags 670 are not set to “ON,” determines that there is a job or jobs yet to be processed (S1013: NO), and returns to S1001.

If there is a job or jobs yet to be processed, the CPU 201 repeats the processes of S1001 to S1012. In the example of FIG. 4, the re-generated proof job J0013 and the proof jobs J0010, J0012, and J0015 are determined to be proof jobs to be continuously printed with the proof job J0013 as the leading job. The total of the print lengths of these proof jobs J0013, J0010, J0012, and J0015 is 1 m+2 m+2 m+1 m=6 m, which exceeds the conveyance path length B. Thus, the proof jobs are continuously printed on the region 403 behind the final printing region 402 (print jobs J0001, J0003, and J0007), so that a series of proof region 403 are disposed.

Thereafter, print jobs associated with proof jobs with proofs determined as acceptable among the proof jobs J0013, J0010, J0012, and J0015 are continuously printed on a region following the proof region 403 (not illustrated). Subsequently, similar processes are repeated and, if it is determined that there is no job yet to be processed in the job list 1300 (S1013: YES), the process of the flowchart is terminated.

As described above, by performing the print control process in the first embodiment, the printing system 100 using the roll sheet P consistently from sheet feed to sheet discharge can prevent a blank portion from appearing between proof printing and final printing. Specifically, in the first embodiment, multiple proof jobs are collectively and continuously printed on a first region on the roll sheet P, and final printing is performed on a second region following the first region. In this way, the second and subsequent jobs are also subjected to proof printing on the region preceding the region for the final printing of the first job. This can prevent blank portions from appearing on the continuous sheet.

In particular, in the first embodiment, multiple proof jobs to be continuously printed are determined such that they are longer than the distance from the visual check position to the print position (conveyance path length B). In this way, the portion which has conventionally been conveyed without being printed for the purpose of a visual check will not be blank and will be printed.

Note that, in the above description, the print length of multiple proof jobs is determined so as to exceed the distance from the visual check position to the print position (conveyance path length B). Here, in a case where the total of the print lengths of all the proof jobs in the job list does not exceed the conveyance path length B, the subsequent process may be determined based on the operator's determination. For example, it may be possible to employ a configuration which waits to receive a next proof job in a case where the operator determines that there is sufficient time before the deadline, and immediately starts the printing even without the print length of the multiple proof jobs exceeding the conveyance path length B in a case where the operator determines that there is not sufficient time before the deadline.

This process is illustrated in the flowchart illustrated in FIG. 11. Specifically, if the total C of the print length Lp of the proof jobs is less than or equal to the conveyance path length B in S1105 and there is not a next proof job in the job list (S1105: NO→S1106: NO), the CPU 201 proceeds to S1109.

In S1109, the CPU 201 accepts input of a print start instruction from the operator. In response to input of the start instruction (S1109: YES), the CPU 201 moves to S1108. In S1108, the CPU 201 determines the leading proof job, which was not subjected to the addition to the value C, and the proof job or proof jobs which were subjected to the addition in S1104 as proof jobs to be continuously printed. If a start instruction is not input (S1109: NO), the CPU 201 terminates the flowchart of FIG. 11. The proof jobs determined as proof jobs to be continuously printed are stored in the job queue 520 in S1002 in FIG. 10, and start to be printed.

Even in a case where the total C of the print lengths Lp of the proof jobs is less than or equal to the conveyance path length B, the process of S1109 makes it possible to start the proof printing registered in the job list if a print start instruction is input by the operator. In this case, a blank may appear between the proof region 401 and the final printing region 402, but the blank portion can be reduced as compared to the conventional example (FIG. 3) as long as multiple proof jobs are continuously printed.

Note that, in the present embodiment, an example has been presented in which, as indicated by images 410 in FIG. 4, characters that humans can recognize such as job IDs and print setting IDs are printed near proof images, but pieces of information such as job IDs and print setting IDs may be printed in the form of codes (such as two-dimensional codes). In that case, the configuration may be such that, when inputting a proof evaluation result, the operator uses a code reader or the like to read and input the job ID, which would otherwise be manually input into the UI 1200.

Also, in the present embodiment, a job is generated and then a raster image or raster images are generated (S703, S704), but the present embodiment is not limited to this procedure. For example, raster images may be generated before print targets are stored in the job queue 520 after they are determined (S1002, S1008).

Also, in the present embodiment, acceptance of a print job is immediately followed by configuration of the proof settings and generation of a proof job, but the procedure is not limited to this timing. For example, multiple print jobs may be continuously accepted, and then the proof settings may be configured and proof jobs may be generated at any timing which the operator desires.

Also, in the present embodiment, a single proof job is printed for a single print job, but multiple proof jobs (sets of print settings) may be set for a single print job, and those multiple proof jobs may be continuously printed. In that case, from among the printed results of the multiple proof jobs (sets of print settings), the operator may select the set of print settings which the operator determines as the best print settings, and final printing may be executed with those print settings.

Also, in the present embodiment, an example in which the conveyance path length B is used as a preset value has been presented. Here, the apparatus configuration of the printing system 100 can be changed as appropriate, and the conveyance path length B may change according to the apparatus configuration. In that case, the CPU 201 may have a function of determining and setting the conveyance path length B based on the apparatus configuration of the printing system 100. Specifically, the CPU 201 may obtain the distance of the conveyance path from the print position 111 in the printing apparatus 101 to the visual check position 112 in the inspection apparatus 104 and, in a case where another apparatus is disposed therebetween, the distance of the conveyance path in that apparatus, and determine and set the conveyance path length B based on those distances.

Also, in the description of the present embodiment, the printing apparatus 101 and the host apparatus 140 are connected to each other through a network such as a LAN, as illustrated in FIG. 1, but data may be exchanged between the apparatuses in an off-line state by using a USB flash drive or the like.

Also, in the present embodiment, an example in which the CPU 201 of the control unit 200 in the main body of the printing apparatus 101 configures and generates proof jobs, but the present disclosure is not limited to this example. For example, the host apparatus 140, a web application connected through a network, or the like may be used to configure and generate proof jobs in advance, and those jobs may be transmitted to the printing apparatus 101. In this case, information on the associations between the print jobs and the proof jobs is transmitted to the printing apparatus 101 at the same time as well.

### Second Embodiment

Next, a second embodiment of the present disclosure will be described.

In the first embodiment, an example has been described in which continuous printing of multiple proof jobs and continuous printing of print jobs associated with the printed proof jobs as their source jobs (final printing) are repeated on the same roll sheet P. Also, an example in which the proof jobs to be continuously printed are determined according to the distance B from the print position to the visual check position has been described.

In the second embodiment, another method of determining the proof jobs to be continuously printed will be presented. Specifically, the printing apparatus 101 in the second embodiment firstly determines jobs to be printed on a single roll and then continuously prints proof jobs among those jobs on a first region 1410 on the leading side of the roll sheet P. The printing apparatus 101 then continuously performs final printing for a single roll on a second region 1420 following the first region 1410. In the second embodiment too, it is possible to prevent the blank portion from appearing between proof printing and final printing as in the first embodiment.

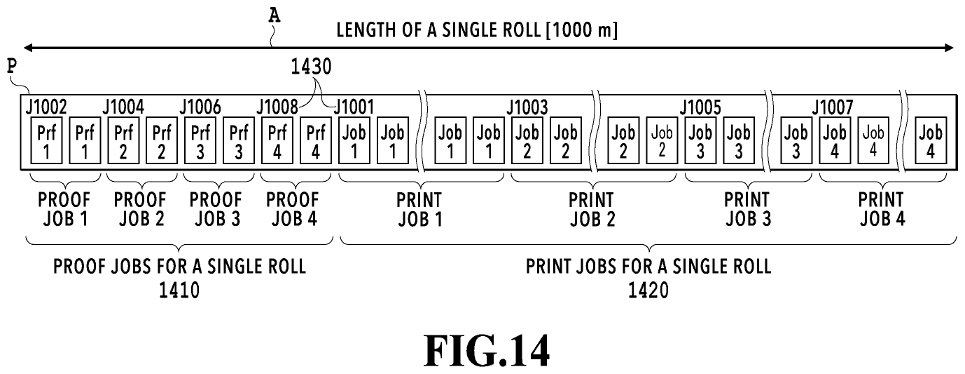

FIG. 14 is a diagram illustrating an example of the result of printing by the printing apparatus 101 in the second embodiment. In the second embodiment, the printing apparatus 101 determines proof jobs and print jobs to be printed on a single roll of the roll sheet P based on the length of the single roll (hereinafter referred to as “roll sheet length A”). Then, the printing apparatus 101 collectively and continuously prints the proof jobs for a single roll thus determined (proof jobs 1, 2, 3, and 4) on the first region 1410, which is a region on the leading side of the roll sheet P. The printing apparatus 101 also continuously performs final printing for a single roll (print jobs 1, 2, 3, and 4) on the second region 1420 following the first region 1410.

The hardware configuration (FIG. 1) and the control configuration (FIG. 2) of the printing system 100 in the second embodiment are similar to those in the first embodiment. Thus, the same parts are denoted by the same reference signs, and overlapping description is omitted.

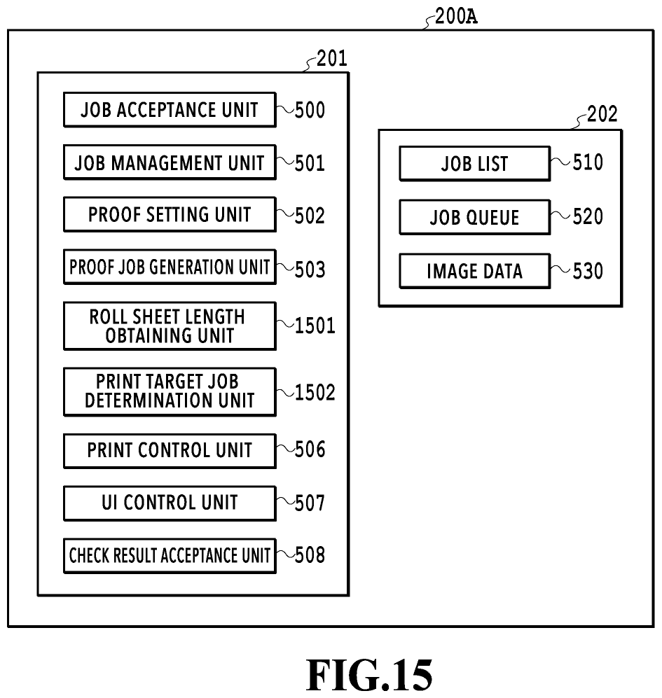

FIG. 15 is a block diagram illustrating a functional configuration of the printing apparatus 101 in the second embodiment. In the second embodiment, a control unit 200A has a job acceptance unit 500, a job management unit 501, a proof setting unit 502, a proof job generation unit 503, a roll sheet length obtaining unit 1501, a print target job determination unit (hereinafter “determination unit”) 1502, a print control unit 506, a UI control unit 507, a check result acceptance unit 508, and so on. Also, a RAM 202 stores pieces of information such as a job list 510, a job queue 520, image data 530, and so on.

The functional configuration differs from that in the first embodiment (FIG. 5) in that the roll sheet length obtaining unit 1501 is included and in the method by which the determination unit 1502 determines printing targets. The job acceptance unit 500, the job management unit 501, the proof setting unit 502, the proof job generation unit 503, the print control unit 506, the UI control unit 507, and the check result acceptance unit 508 are similar to those in the first embodiment.

The roll sheet length obtaining unit 1501 obtains the roll sheet length A, which is the length of a single roll of roll sheet (continuous sheet P). In the following description, the roll sheet length A is 1000 m as an example. The operator may input the value of the roll sheet length A, or a configuration to obtain the roll sheet length A from the roll set in the sheet feed unit 102 may be employed.

In the case of obtaining the roll sheet length A from the roll, for example, code information such as a barcode printed on the side surface of the roll core is read with a barcode reader, and information of the roll sheet length associated with the code information is obtained. Alternatively, a radio-frequency identification (RFID) tag incorporated in the roll core may be read with a reader to obtain information of the roll sheet length stored in the tag associated with the tag.

The determination unit 1502 determines proof jobs and print jobs to be printed on a single roll based on the print lengths 620 of the proof jobs and the print jobs registered in the job list 510 and the roll sheet length A obtained by the roll sheet length obtaining unit 1501.

To determine the jobs to be printed, the determination unit 1502 calculates a total D of a print length Lj of a proof jobs and a print length Lp of the proof job whose source job is that print job. Then, the determination unit 1502 adds the print lengths Lj and Lp of jobs until the total D exceeds the roll sheet length A. Note that, In the calculation the total D, the determination unit 1502 adds the print lengths Lj and Lp of jobs in the order of registration in the job list. Here, for each pair of a print job and a proof job whose source job is that print job, the print length Lp of the proof job is added first (D=Lp+Lj).

The determination unit 1502 determines the print jobs and proof jobs subjected to the addition to the total D as the jobs to be printed for a single roll, and determines the proof jobs among those jobs as jobs to be continuously printed on the leading region 1410.

The print control unit 506 collectively and continuously prints the proof jobs determined by the determination unit 1502 on the leading region 1410 on the roll sheet P. Then, the print control unit 506 executes final printing of the print jobs associated with the printed proof jobs on the region 1420 following the region 1410, on which the proof jobs have been printed. Note that, in a case where there is a remaining page or pages in a print job that cannot be printed on the single roll, the job will be taken over to the next roll, and the remaining page or pages will be printed on a leading portion of the next roll.

In the second embodiment too, as in the first embodiment, the CPU 201 (job acceptance unit 500, job management unit 501, proof setting unit 502, and proof job generation unit 503) manages jobs. The CPU 201 executes the job acceptance and proof job generation process illustrated in FIG. 7 and sequentially stores the accepted print jobs and the generated proof jobs in the job list. The CPU 201 also determines the print length of each job and registers it in the job list.

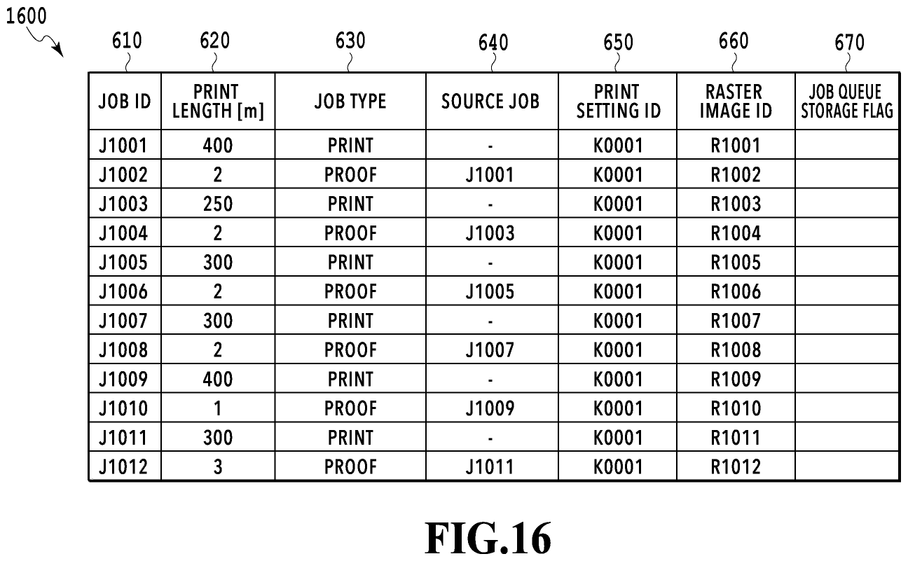

FIG. 16 is an example of a job list 1600 used in the description of the second embodiment. Items 610 to 670 in the job list 1600 are similar to those in the job lists illustrated in FIGS. 6 and 13. Note that the values of the job IDs 610 and the values of the print lengths 620 are different from those in the job list 600 in FIG. 6.

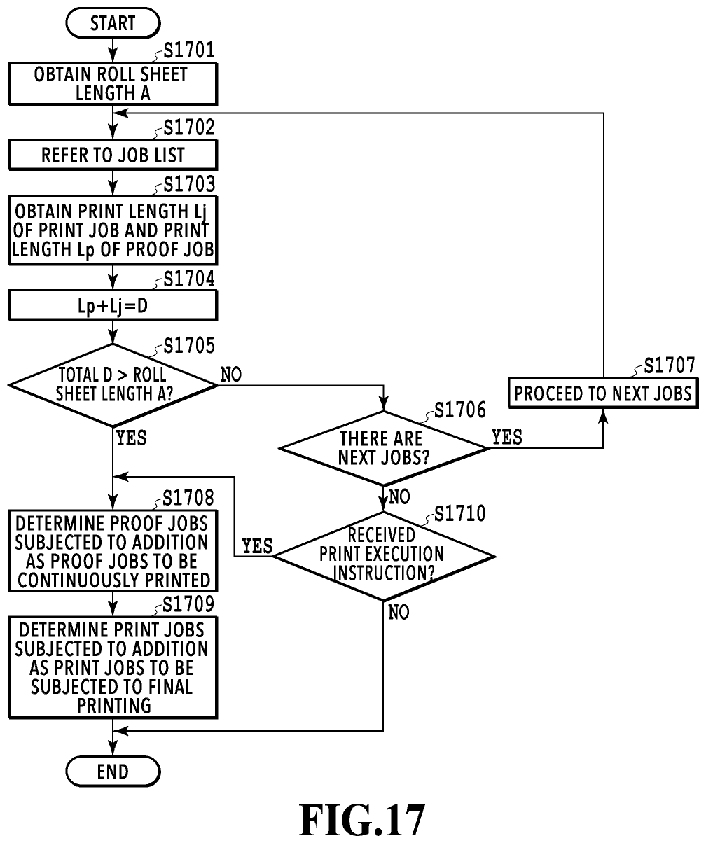

Next, a process executed the printing apparatus 101 in the second embodiment will be described. FIG. 17 is a flowchart illustrating a flow of a process of determining jobs to be printed in the second embodiment. Note that the process in the flowchart of FIG. 17 is executed in S1001 in the print control process in FIG. 10 (first embodiment). Suppose that the job list 1600 illustrated in FIG. 16 have been registered when the flowchart of FIG. 17 is started. Also, the CPU 201 initializes a variable D (=0) to be used in the following calculation.

In S1701, the CPU 201 (roll sheet length obtaining unit 1501) obtains the length of a single roll of the roll sheet P (roll sheet length A). This example will be described on the assumption that the length of a single roll is 1000 m.

In S1702, the CPU 201 (determination unit 1502) sequentially refers to jobs registered in the job list 1600 from the top job.

In S1703, the CPU 201 (determination unit 1502) obtains the print length of each referred job. In a case where the referred job is a print job, the CPU 201 obtains its print length Lj. Further, the CPU 201 obtains the print length Lp of the proof job whose source job is that print job.

In S1704, the CPU 201 (determination unit 1502) adds the obtained the print lengths Lj and Lp to the variable D. In doing so, of the print lengths of the print job and the proof job whose source job is that print job, the CPU 201 adds the print length of the proof job first (Lp+Lj=D).

In S1705, the CPU 201 (determination unit 1502) determines whether the total D in S1704 exceeds the roll sheet length A. The CPU 201 proceeds to S1708 if the total D exceeds the roll sheet length A, and proceeds to S1706 if the total D is less than or equal to the roll sheet length A.

In S1706, the CPU 201 (determination unit 1502) determines whether there are next jobs in the job list 1600. The CPU 201 proceeds to S1707 if there are next jobs. The CPU 201 proceeds to S1710 if there are not next jobs.

In S1707, the CPU 201 proceeds to the next jobs in the job list and returns to S1702. The processes of S1702 to S1707 are repeated to add the print lengths Lp of proof jobs and the print lengths Lj of print jobs to the value D. The CPU 201 repeats the addition until the total D exceeds the roll sheet length A (1000 m).

If the total D exceeds the roll sheet length A (1000 m), then in S1708, the CPU 201 (determination unit 1502) determines the proof jobs among the jobs used in the addition to the value D as proof jobs to be continuously printed on the first region 1410, which is the leading region.

In S1709, the CPU 201 (determination unit 1502) tentatively determines the print jobs among the jobs used in the addition to the value D as print jobs to be subjected to final printing. The tentative determination is made because a source job will not be printed in a case where the result of its proof evaluation is unacceptable.

In the example using the job list 1600 in FIG. 16,

$$D = 2 m ( J 1002 ) + 400 m ( J 1001 ) + 2 m ( J 1004 ) + 250 m ( J 1003 ) + 2 m + 300 m ( J 1005 ) + 2 m ( J 1008 ) + 300 m ( J 1007 ) > 1000 m .$$

Thus, the CPU 201 determines the proof jobs J1002, J1004, J1006, and J1008 as proof jobs to be continuously printed on the first region 1410. The CPU 201 also tentatively determines the print jobs J1001, J1003, J1005, and J1007 as print jobs to be printed on the following region.

Also, if the total D is less than or equal to the roll sheet length A (S1705: NO) even after adding the print lengths Lp and Lj of all print jobs and proof jobs registered in the job list 1600, the subsequent process may be determined based on the operator's determination. Specifically, as in the first embodiment (S1106: NO→S1109 in FIG. 11), if determining in S1705 that the total D is less than or equal to the roll sheet length A and determining in S1706 that there are not next jobs, the CPU 201 proceeds to S1710.

In S1710, the CPU 201 accepts input of a print start instruction from the operator. In response to input of the start instruction (S1710: YES), the CPU 201 moves to S1708.

In S1708, the CPU 201 determines the jobs used in the addition to the value D as jobs to be printed on the single roll, and determines the proof jobs among those jobs as proof jobs to be continuously printed.

In S1709, the CPU 201 tentatively determines the print jobs among the jobs used in the addition to the value D as print jobs to be subjected to final printing.

After the process of S1709 is finished or if no start instruction is input in S1710 (S1710: No), the CPU terminates the flowchart and moves to S1002 in FIG. 10. The processes in and after S1002 are similar to those in the first embodiment.

The proof jobs determined as proof jobs to be continuously printed are stored in the job queue 520 in S1002 in FIG. 10, and sequentially start to be printed. In the above example, the proof jobs J1002, J1004, J1006, and J1008 are stored in the job queue 520 in this order. The CPU 201 also sets the job queue storage flags 670 for these proof jobs J1002, J1004, J1006, and J1008 to “ON.”

The CPU 201 refers to the job queue 520 and the job list 1600 managed by the job management unit 501 and sequentially issues print start instructions to the printing unit 103. In doing so, the CPU 201 issues instructions to print the job IDs 610 and the print setting IDs 650 near the proof images. The CPU 201 sets print instructions, print data, and the like in the printing unit 103 with the print start instructions. The printing unit 103 ejects an ink or inks to continuously print the proof jobs on the roll sheet P.

As illustrated in FIG. 14, the proof jobs J1002, J1004, J1006, and J1008, each of which is 2 m, are continuously printed to form a continuous proof region 1410. The length of the proof region 1410 is 8 m. Also, in a case where the proofs of these proof jobs J1002, J1004, J1006, and J1008 are determined as acceptable, the source job J1001 of the proof job J1002 (400 m), the source job J1003 of the proof job J1004 (250 m), the source job J1005 of the proof job J1006 (300 m), and the source job J1007 of the proof job J1008 (300 m) will be sequentially printed on the following region 1420, which is a 992 m region.

Here, any part of the print jobs to be continuously printed that is outside the length of the following region 1420 (992 m) will be subsequently printed on the next roll after current the roll is replaced. Specifically, the print job J1007 is printed only for 42 m on the first roll, and the remaining 258 m will be printed on the second roll. Note that, in the case of replacing a roll in the middle of a job, the remaining length in the queue is determined on a per-page basis so that the printing will not be stopped while a page is printed.

As described above, in a case where a printing system using a continuous sheet performs proof printing, performing the print control process in the second embodiment can prevent the blank from appearing between the proof printing and the final printing. In the second embodiment, proof jobs for a single roll are determined such that the total of the print lengths of the proof jobs and the print jobs to be continuously printed exceeds the entire length of the continuous sheet. This makes it possible to perform printing on the blank portions that would otherwise appear in the conventional case.

Also, even in a case where the total D of the print lengths Lp and Lj of the proof jobs and the print jobs to be continuously printed is less than or equal to the length of the continuous sheet P, the proof printing can be started in response to input of a print start instruction from the operator. In this case, executing the proof printing and the final printing may not reach the length of a single roll. Nonetheless, the continuous printing of the multiple proof jobs can reduce the blank portion as compared to the conventional example (FIG. 3).

### Third Embodiment

Next, a third embodiment will be described. In the above second embodiment, the result of the proof evaluation on a proof job printed on the leading region 1410 on the roll sheet P is unacceptable, it is impossible to execute the final printing of the print job which is the source job for that proof job. In that case, there is a possibility that the total D of the print lengths will not reach the roll sheet length A (1000 m) and some printable portion of that roll sheet P will be left unprinted.

To prevent this, the third embodiment involves setting one or more extra proof jobs as targets to be continuously printed on the first region (proof region) in addition to the proof jobs to be continuously printed that are determined by the method in the second embodiment.

The hardware configuration (FIG. 1) and the control configuration (FIG. 2) of the printing system 100 in the third embodiment are similar to those in the first embodiment. Thus, the same parts are denoted by the same reference signs, and overlapping description is omitted.

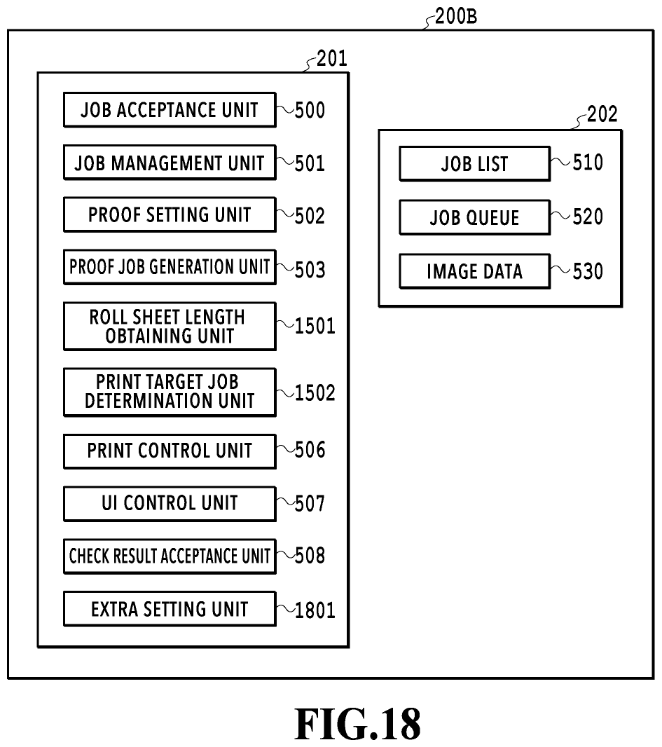

FIG. 18 is a block diagram illustrating a functional configuration of the printing apparatus 101 in the third embodiment. In the third embodiment, a control unit 200B of the printing apparatus 101 has an extra setting unit 1801 in addition to the functional configuration in the second embodiment (FIG. 15). Its job acceptance unit 500, job management unit 501, proof setting unit 502, proof job generation unit 503, roll sheet length obtaining unit 1501, print target job the determination unit 1502, print control unit 506, UI control unit 507, and check result acceptance unit 508 are similar to those in the first or second embodiment, and description thereof is therefore omitted.

The extra setting unit 1801 adds a predetermined number of extra proof jobs to the proof jobs to be continuously printed. The number of extra proof jobs is a preset number or a number set by the operator. In the case of accepting setting of the number of extra proof jobs by the operator, the extra setting unit 1801 preferably displays a UI for accepting input of the number of extra proof jobs on the operation panel 206.

The extra setting unit 1801 determines the number of extra proof jobs based on the roll sheet length A and the information of the print lengths Lj and Lp of the proof jobs and the print jobs. A method of determining the number of extra proof jobs will now be described below.

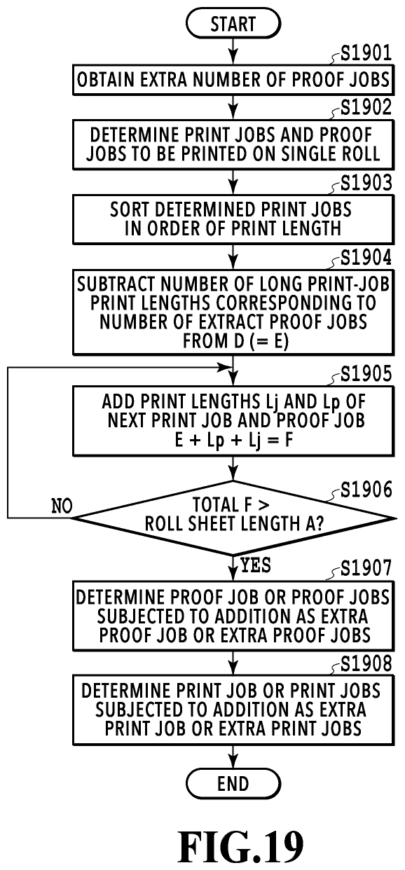

FIG. 19 is a flowchart illustrating a flow of a process of determining jobs to be printed in the third embodiment. Note that the flowchart of FIG. 19 is a process executed in S1001 in the print control process illustrated in FIG. 10. The contents of the job list 1600 at the time of starting the flowchart are in the state of FIG. 16. Also, the roll sheet length A is 1000 m. The CPU 201 initializes variables D, E, and F to be used in the following calculation.

In S1901, the CPU 201 (extra setting unit 1801) obtains the preset number of extra proof jobs. Alternatively, the CPU 201 may display the UI for inputting the number of extra proof jobs on the operation panel 206 and accept setting of the number of extra proof jobs by the operator. As an example, a case where the number of extra proof jobs is one will be described.

In S1902, the CPU 201 tentatively determines the print jobs and the proof jobs to be printed on a single roll. The method determining the jobs in S1902 is similar to the method in the second embodiment illustrated in FIG. 17. Specifically, the CPU 201 adds the print lengths Lj and Lp of print jobs and proof jobs in the job list 1600 (Lp+Lj=D) from the top job until the total exceeds the roll sheet length A of a single roll. Then, the CPU 201 determines the jobs up to the first print job after the total D exceeds the roll sheet length A as the jobs to be printed on a single roll.

In the example of the second embodiment, as illustrated in FIG. 14, the proof jobs J1002, J1004, J1006, and J1008 and the print jobs J1001, J1003, J1005, and J1007 are tentatively determined as the jobs to printed on a single roll.

The total D of the print lengths of these jobs is

$$D = 2 m ( J 1002 ) + 400 m ( J 1001 ) + 2 m ( J 1004 ) + 250 m ( J 1003 ) + 2 m + 300 m ( J 1005 ) + 2 m ( J 1008 ) + 300 m ( J 1007 ) = 1258 m .$$

In S1903, the CPU 201 sorts the tentatively determined print jobs J1001, J1003, J1005, and J1007 in order of print length. Referring the job list 1600 in FIG. 16, the print jobs are sorted in the order of J1001 (400 m), J1005 (300 m), J1007 (300 m), and J1003 (250 m).

In S1904, from the total D, the CPU 201 subtracts a number of large print lengths Lj corresponding to the number of extra proof jobs. In this example, the number of extra proof jobs has been set to one. Thus, the CPU 201 subtracts the length of the longest print job J1001 (400 m) from the value D. The value E after the subtraction is

$$E = D ( 1258 m ) - J 1001 ( 400 m ) = 858 m .$$

In a case where the number of extra proof jobs is two, the CPU 201 subtracts the two longest print lengths (J1001 (400 m) and J1005 (300 m)).

In S1905, the CPU 201 adds the print lengths Lj and Lp of jobs that were not added in the process of S1902 among the jobs registered in the job list to the value E. The numbers of print jobs and their proof jobs are each the number of extra proof jobs. Also, the order of the addition is such that, of the print lengths of the pair of the print job and the proof job whose source job is that print job, the print length of the proof job is added first. In a case where the number of extra proof jobs is two or more, the print lengths are added in the order of registration in the job list. The result of the calculation in S1905 is a value F.

Specifically, the value F is calculated as

$$F = E ( 858 m ) + 1 m ( j 1010 ) + 400 m ( J 1009 ) = 1259 m .$$

In S1906, the CPU 201 determines whether the value F calculated in S1905 exceeds the roll sheet length A. If the value F is less than or equal to the roll sheet length A (S1906: NO), the CPU 101 returns to S1905 and adds the print lengths Lj and Lp of the next print job and proof job. If the value F exceeds the roll sheet length A, the CPU 201 proceeds to S1907.

In S1907, of the jobs used in the calculation (of the value F) in S1905 (J1010 and J1009), the CPU 201 adds the proof job J1010 as an extra proof job to the proof jobs to be continuously printed. In the above example, the extra proof job J1010 is added to the proof jobs J1002, J1004, J1006, and J1008 tentatively determined in S1902. The CPU 201 determines these proof jobs J1002, J1004, J1006, J1008, and J1010 are proof jobs to be continuously printed.

In S1908, the CPU 201 determines the print job J1009 among the jobs used in the calculation in S1905 (J1010 and J1009) as an extra print job. In the above example, the extra print jobs J1009 is added to the print jobs J1001, J1003, J1005, and J1007 tentatively determined in S1902.

The above process concludes the flowchart.

The proof jobs determined as proof jobs to be continuously printed are stored in the job queue 520 in S1002 in FIG. 10, and start to be printed. Specifically, the CPU 201 refers to the job list 1600 and stores the determined proof jobs in the job queue 520 in the order of registration in the job list 1600. In the above example, the proof jobs J1002, J1004, J1006, J1008, and J1010 are stored in the job queue 520 in this order. The CPU 201 also sets the job queue storage flags 670 for these proof jobs J0002, J0004, J0006, J0008, and J010 in the job list 1600 to “ON.”

By setting an extra proof job as described above, it will be possible to execute printing without a blank portion appearing on the roll sheet P even in a case where the result of the proof evaluation of any of the continuously printed proof jobs is unacceptable.

Embodiments according to the present disclosure have been described above with reference to the accompanying drawings. However, the present disclosure is not limited to those examples. Additionally, it is apparent that those skilled in the art can arrive at various modifications and corrections within the purview of the technical idea disclosed in the present application, and it is to be understood that they naturally belong to the technical scope of the present disclosure.

In accordance with the present disclosure, it is possible to prevent a blank portion from appearing between test printing and final printing for printing on a continuous sheet.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-205282, filed Dec. 5, 2023, which is hereby incorporated by reference wherein in its entirety.

What is claimed is:

1. A printing apparatus comprising:
a printing unit configured to execute printing on a continuous sheet; and
a control unit configured to control the printing unit based on a print job including a first job for test printing and a second job for final printing, wherein
in a case where a plurality of the print jobs are input, the control unit controls the printing unit so as to
collectively print the plurality of first jobs in the input plurality of print jobs on a first region on the continuous sheet, and
collectively print the plurality of second jobs in the input plurality of print jobs on a second region present on a rear side in a conveyance direction of the continuous sheet relative to the first region on the continuous sheet on which the first jobs have been printed.

2. The printing apparatus according to claim 1, wherein the second region is adjacent to the first region.

3. The printing apparatus according to claim 1, further comprising a determination unit configured to determine the plurality of first jobs to be printed on the first region.

4. The printing apparatus according to claim 3, wherein the determination unit determines the plurality of first jobs to be printed on the first region based on a conveyance path length that is a length of a conveyance path for the continuous sheet from a print position on the conveyance path to a position on the conveyance path at which a print result is visually checkable.

5. The printing apparatus according to claim 4, wherein the determination unit determines the plurality of first jobs to be printed on the first region such that a total of lengths over which to print the first jobs excluding the first job to be printed first among the plurality of first jobs to be printed on the first region exceeds the conveyance path length.

6. The printing apparatus according to claim 5, further comprising a starting unit configured to start the printing in response to an instruction from an operator in a case where the total is less than or equal to the conveyance path length.

7. The printing apparatus according to claim 4, further comprising a setting unit configured to set the conveyance path length according to an apparatus configuration.

8. The printing apparatus according to claim 4, wherein the control unit performs control such that the first region is further disposed on a rear side relative to the second region.

9. The printing apparatus according to claim 3, wherein the determination unit determines the plurality of first jobs to be printed on the first region based on an entire length of the continuous sheet.

10. The printing apparatus according to claim 9, wherein the determination unit determines the plurality of first jobs to be printed on the first region such that a total of lengths over which to print the first jobs and the second jobs exceeds the entire length of the continuous sheet.

11. The printing apparatus according to claim 10, further comprising a starting unit configured to start the printing in response to an instruction from an operator in a case where the total is less than or equal to the entire length of the continuous sheet.

12. The printing apparatus according to claim 9, further comprising an extra setting unit configured to set the first job as an extra first job to be printed on the first region.

13. The printing apparatus according to claim 3, further comprising a result acceptance unit configured to accept input of results of checks on print results of the first jobs by an operator, wherein
the determination unit determines the second job associated with the first job for which the result acceptance unit has accepted an input indicating permission to execute final printing, as a second job to be printed on the second region.

14. The printing apparatus according to claim 1, wherein the control unit controls the printing unit so as to print pieces of identification information of the print jobs near images of the print jobs.

15. A print control method for controlling printing on a continuous sheet in which the printing is controlled based on a print job including a first job for test printing and a second job for final printing, the print control method comprising, in a case where a plurality of the print jobs are input:
collectively printing the plurality of first jobs in the input plurality of print jobs on a first region on the continuous sheet; and
collectively printing the plurality of second jobs in the input plurality of print jobs on a second region present on a rear side in a conveyance direction of the continuous sheet relative to the first region on the continuous sheet on which the first jobs have been printed.

16. A non-transitory computer readable storage medium storing a program which causes a computer to execute a print control method for controlling printing on a continuous sheet in which the printing is controlled based on a print job including a first job for test printing and a second job for final printing, the print control method, in a case where a plurality of the print jobs are input:
collectively printing the plurality of first jobs in the input plurality of print jobs on a first region on the continuous sheet; and
collectively printing the plurality of second jobs in the input plurality of print jobs on a second region present on a rear side in a conveyance direction of the continuous sheet relative to the first region on the continuous sheet on which the first jobs have been printed.
